(19) United States
(12) Patent Application Publication
(10) Pub. No.: US 2006/0073453 A1
(43) Pub. Date: Apr. 6, 2006

(54) Rosary chain jointing device

(76) Inventor: Alessandro Ghirelli, Santa Maria Maddalena (RO) (IT)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/947,340

(22) Filed: Sep. 23, 2004

(51) Int. Cl. G09B 19/00

(52) U.S. Cl. 434/245

(57) ABSTRACT

A rosary chain jointing device comprising at least two generally flat elements joined with each other in a way to allow said elements to be opened like a book, one of said elements having connecting means on the extremities connected to the chains of the rosary crown.

### BACKGROUND OF THE INVENTION

This invention refers to a rosary chain jointing device, in other words a connecting means situated in rosary chains between the main crown and the appendix.

As is well-known, the rosary is an item used during the recitation of prayers, consisting of a chain carrying a row of beads assembled in groups of ten and spaced out by a bead that separates each group from the other, where each group represents a Mystery of the Rosary.

The chain of the Mysteries of the Rosary is a loop closed by a connecting means which joins the two extremities of the chain together and also couples another length of the chain arranged in the center relatively to the other two portions on the opposite side of the chain loop.

This connecting means generally takes different shapes like that, for instance, of a basically triangular metal medallion on which are depicted images of saints, or at any rate religious images or short phrases of holy type.

This medallion generally is a flat element with no other purpose than that of being a connecting means.

### SUMMARY OF THE INVENTION

The present invention aims at improving the usefulness of the rosary crown giving to the connecting means, or jointing device, a further functionality other than that of being a connecting means.

In fact, the aim is to obtain that the rosary crown should contain helpful explanations for prayer recitation, for example on the Rosary Mysteries to recite, or notes to reflect upon, dedications or similar.

Another aim is to obtain a rosary crown that when necessary may comprise in itself, without showing them, images, dedications, photographs or religious relics or photographs of loved ones as portrait-holders; or it may contain a brief biography of a saint with the main events of the saint's life; or yet become a short summary of the Gospels or of the Bible in general.

The object of the invention is thus to provide to the person who uses the rosary crown an informative support that is discreetly accessible to the owner of the rosary crown.

These and other objects are obtained by a rosary crown that has a rosary chain jointing device which, in accordance with the first claim, is characterized by the fact that it comprises at least two basically flat elements hinged together in order to allow for said elements to open like a book, one of said elements having connecting means on three extremities making up the rosary crown.

### BRIEF DESCRIPTION OF THE DRAWINGS

Further details and characteristics are better highlighted in the description of a preferred executive embodiment of the invention given in an explanatory but not limiting way, illustrated in the annexed drawings, wherein:

FIG. 1 shows a rosary crown with the jointing device of the invention;

FIG. 2 shows the open jointing device of the invention;

FIG. 3 shows a variation of the jointing device of the invention of FIGS. 1 and 2;

FIG. 4 shows a section of the device of FIG. 3;

FIGS. 5 and 6 show different shapes of the device of the invention.

### DESCRIPTION OF THE INVENTION

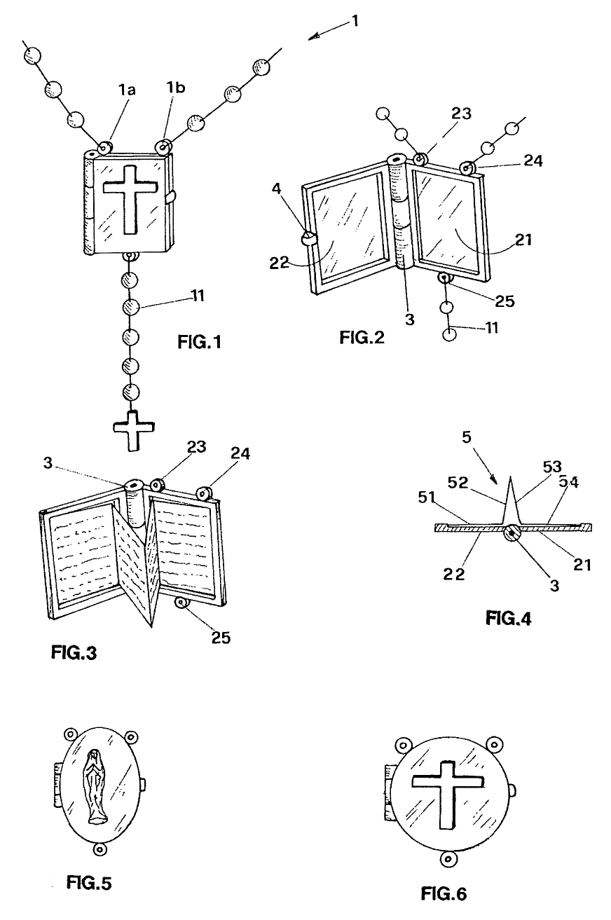

With reference to the cited figures, it can be seen that the rosary crown, generally indicated with 1, has the two extremities 1a and 1b connected to a jointing device, generally indicated with 2. Said jointing device, as can be seen in FIG. 1, comprises two basically flat metal elements 21 and 22 joined together with each other by a hinge 3.

In a different executive embodiment the two flat elements could be joined by another jointing means, like for instance a dap joint, as long as this enables the two elements to rotate around a common axis allowing them both to overlap and open.

The flat element 21 has eyelets 23, 24 and 25. The eyelets 23 and 24 are connected to the extremities of the rosary crown 1a and 1b, respectively. To the eyelet 25 is connected a further length of the rosary crown indicated with 11.

The two elements 21 and 22 joined by the hinge 3 entirely make up the cover of a small book that may be closed with a closing means, indicated with 4. Such closing means may simply comprise, for example, of two protrusions that overlap one another or that interfere with one another and make some resistance that can easily be overcome by maneuvering with the fingers in opposite directions causing it to open.

On the inside of each surface of the elements 21 and 22 may be inserted writings, images, relics, or still, as can be seen in FIG. 3, a paper support of several pages may be inserted as well. The front-page of the cover of the boo,k thus shaped may represent a sacred image, while on the back there may be a phrase copied from the Bible. In the example shown in FIGS. 3 and 4, on the inside of the two cover pages 21 and 22 that make up a kind of book, a laminate material is inserted for example of paper, or plastic coated paper, consisting of a sheet 5 made up by several sheets 51, 52, 53 and 54 in which page 51 and page 54 are glued unto the internal surface of the flat elements 22 and 21, respectively. Generally, the paper or, for instance, plastic film supports can have several pages as shown in FIGS. 3 and 4 and thus on the inside of the cover 21 and 22 a small booklet can be inserted for consultation.

As said, in it may be written the Mysteries of the Rosary or notes to reflect upon, dedications or similar in aid of spiritual elevation and aiding the recitation itself.

It is therefore understood that the invention realizes a means of connection of the rosary crown with an additional function to the specific one it absolves, being able to contain internally the informative support as described above.

Naturally, the shape of the jointing device may vary, since it is not necessary for example that the flat elements take a rectangular shape as shown in FIGS. 1 to 4. For this reason the shape of the jointing device may be elliptical or still circular, as shown in FIGS. 5 and 6 or in whichever other shape.

1. A rosary chain jointing device wherein it comprises at least two elements generally flat and connected with each other, in order to allow said elements to open like a book, one of said elements having connecting means on the extremities connected to the chains of the rosary crown.

2. The device according to claim 1, wherein at least two of said elements are joined by a hinge.

3. The device according to claim 1, wherein it has a closing means between at least two of said elements.

4. The device according to claim 2, wherein at least t of said elements hold internally material for informative support.

5. The device according to claim 4, wherein said informative support comprise one or more sheets of laminate material like paper, plastic coated paper, sheet-steel showing impressed images and/or writing.

6. The device according to claim 1, wherein at least two of said flat elements hold internally religious relics or photographs.

7. The device according to claim 2, wherein at least two of said elements are made of metal.

8. The device according to claim 1, wherein it has on the front-page and/or on the back religious images and/or phrases taken from religious texts.

9. The device according to claim 1, wherein said connecting means are one or more eyelets.
